(19) United States
(12) Patent Application Publication
(10) Pub. No.: US 2007/0294613 A1
(43) Pub. Date: Dec. 20, 2007

(54) Communication system for remote collaborative creation of multimedia contents

(75) Inventors: Emmanuel Le Huerou, Saint Quay Perros (FR); Michael Pontiggia, Lannion (FR); Patrice Coupe, Tokyo (JP)

Correspondence Address: COHEN PONTANI LIEBERMAN & PAVANE LLP, Suite 1210, 551 Fifth Avenue, New York, NY, 10176, US

(73) Assignee: France Telecom, Paris (FR)

(21) Appl. No.: 11/807,793

(22) Filed: May 29, 2007

(30) Foreign Application Priority Data
May 30, 2006 (FR) 06/51961

(51) Int. Cl. G06F 17/00

(52) U.S. Cl. 715/500.1

(57) ABSTRACT

A communication system for remote collaborative creation of a final multimedia content produced from a plurality of individual multimedia contents. The system comprises a module for generating a scenario for said final multimedia content, said scenario having a tree structure including at least one multimedia sequence, a plurality of terminals each adapted to send an individual multimedia content having multimedia data and metadata including an indicator relating to a multimedia sequence to which said individual multimedia content relates, and a server for producing said final multimedia content by processing the individual multimedia contents sent by the terminals in accordance with said tree structure and in accordance with a given editing rule. Application to telecommunications and audiovisual activities.

### FIELD OF THE INVENTION

The present invention relates to a communication system for remote collaborative creation of a final multimedia content produced from a plurality of individual multimedia contents.

The invention finds a particularly advantageous application in the field of telecommunications and audiovisual activities.

### BACKGROUND OF THE INVENTION

It has now become easy to produce multimedia contents by editing together sequences available from a multitude of communicating audiovisual equipments. The sequences obtained are assembled by means of video editing software that is widely used on personal computer (PC) type terminals and even on mobile terminals, enabling simplified editing on this type of terminal.

High bit rates enable multimedia contents of good quality to be sent to a large number of fixed or mobile terminals, and those contents are then easy to access and consult. For example, authors of video clips produced on a mobile terminal can therefore easily send clips to recipients by means of MMS messages, electronic mail, etc. or publish them online, for example on a personal web site (known as a “blog”). Moreover, with the data bit rates currently available, it is now becoming possible to consult online video contents on a mobile terminal.

Finally, phones incorporating a camera can feed photos and video to a blog, for example. A blog is inherently collaborative and asynchronous, as it can publish contents coming from different people by means of external links. A video blog can therefore point to video contents produced by different users.

However, all known techniques for producing multimedia contents from individual contents have drawbacks.

Video editing software relates to an individual rather than a collaborative context and generally requires a learning stage because of its complexity.

A plurality of producers/contributors producing a film from a plurality of sources must work in the same place and view the same screens.

With blogs, each content is the work of a single author. Consulting a blog amounts to no more than consulting separate contents successively.

There is thus no simple-to-use system that enables a group of people to produce remotely a single multimedia content made up of individual contributions from members of the group.

### OBJECTS AND SUMMARY OF THE INVENTION

One object of the present invention is to provide a communication system for remote collaborative creation of a final multimedia content from a plurality of individual multimedia contents, which system addresses all requirements arising from collaborative production of multimedia contents by a plurality of people in different places, such as availability of participants and communication between them, and accessing, sharing, processing, and formatting individual contents.

This and other objects are attained in accordance with one aspect of the present invention directed to a communication system for remote collaborative creation of a final multimedia content from a plurality of individual multimedia contents, the communication system comprising:

a module for generating a scenario for said final multimedia content, said scenario including a tree structure having at least one multimedia sequence;

a plurality of terminals, each adapted to send at least an individual multimedia content having multimedia data and metadata including an indicator relating to a multimedia sequence to which said individual multimedia content relates; and

a module for producing said final multimedia content by processing the individual multimedia contents sent by the terminals in accordance with said tree structure and in accordance with a given editing rule.

Thus the system of the invention provides a number of basic collaborative creation operations including:

defining a scenario in the form of a tree of multimedia sequences into which individual contributions from the various participants are placed;

receiving said individual contributions asynchronously and as a function of the availability of the participants, and placing them in the sequence tree according to the indicator attached to each contribution and contained in the metadata; and

producing the final content from the individual contents, allowing for their distribution in the sequences and the editing rule adopted.

An embodiment of the invention offers two options with regard to said indicator and its attachment to a multimedia sequence:

either said indicator concerns a multimedia sequence that exists beforehand in the tree structure;

or said indicator concerns a new multimedia sequence and said generation module is adapted to add said sequence to the tree structure.

In other words, said indicator can associate an individual content either with an existing sequence or with a sequence that is absent from the tree structure. When the sequence is absent, the generation module adds the sequence to the tree structure dynamically.

In one embodiment, said editing rule includes concatenating individual multimedia contents of the same sequence of the tree structure.

In another embodiment, said editing rule includes selecting a single individual multimedia content in a sequence of the tree structure. The multimedia content retained can be the last one received or the one that at least one participant considers to be the best for the sequence concerned. This opinion is transmitted to the system in order to be included in the editing rule if said metadata contains information concerning the constitution of said editing rule, as provided for by the invention.

In a further embodiment, said editing rule includes applying transformations to the individual multimedia contents of the same sequence of the tree structure. Here, “transformations” refers to processing applied to individual contents in isolation, such as slow motion or erasing audio, or to a set of individual contents, such as a fade to black between two successive contents.

In this context, according to the invention, said metadata contains information concerning the application of said transformations when editing the final multimedia content. As a general rule, this information emanates from a particular participant, for example the initiator of the creation process, who functions as the producer of the final content.

Moreover, an embodiment of the invention provides for the terminals to receive status messages from the system.

In particular, said status messages contain information on the availability of the final multimedia content. This feature enables participants to find out if the final multimedia content is available and to request the system to download or stream it.

According to one advantageous feature of the invention, the terminals include a communication interface that enables a participant to use a terminal to send individual contents and metadata and to receive status messages.

If said status messages relate to the last individual multimedia content sent by all the terminals for use in a multimedia sequence, said interface includes an indicator of reception of said last individual multimedia content. There is even provision for said interface to be able to play said last individual multimedia content if the participating user requires this.

According to an embodiment of the invention, said status messages contain alerts relating to the capture of individual multimedia contents by the terminals. These alerts indicate to each participant the role and the type of action expected of that participant, for example.

Another aspect of the invention is directed to a production platform for remote collaborative creation of a final multimedia content from a plurality of individual multimedia contents, the platform comprising:

a module for generating a scenario for said final multimedia content, said scenario including a tree structure having at least one multimedia sequence;

a transceiver stage for receiving individual contents sent by terminals, an individual content consisting of multimedia data and metadata including an indicator relating to a multimedia sequence to which said individual multimedia content relates, and said transceiver stage being adapted to split individual contents into their component parts and to extract said indicator from said metadata; and

a server for producing said final multimedia content by processing individual multimedia contents sent by terminals in accordance with said tree structure and in accordance with a given editing rule.

Other aspects of the invention are directed to a production method and a computer program for executing that method.

The platform, the method, and the computer program have advantages analogous to those of the system described above.

### BRIEF DESCRIPTION OF THE DRAWINGS

The following description with reference to the appended drawings, which are provided by way of non-limiting example, explains the invention and how it can be reduced to practice.

FIG. 1 is a simplified diagram of a system embodiment according to the invention.

FIG. 2 is a detailed diagram of the FIG. 1 system.

FIG. 3 is a diagram of a multimedia sequence tree structure.

FIG. 4 is a diagram showing the distribution of individual multimedia contents in the FIG. 3 tree structure.

FIG. 5 is a diagram of transformations applied to the FIG. 4 individual contents.

FIG. 6 is a diagram of the stage of initializing the production of a final multimedia content.

FIG. 7a is a diagram showing the sending of an individual multimedia content in a nominal production stage.

FIG. 7b is a diagram showing the reception and processing of the individual multimedia content for which FIG. 7a shows the sending.

FIG. 8 is a diagram of the final stage of producing the final multimedia content and making it available.

### DETAILED DESCRIPTION OF THE DRAWINGS

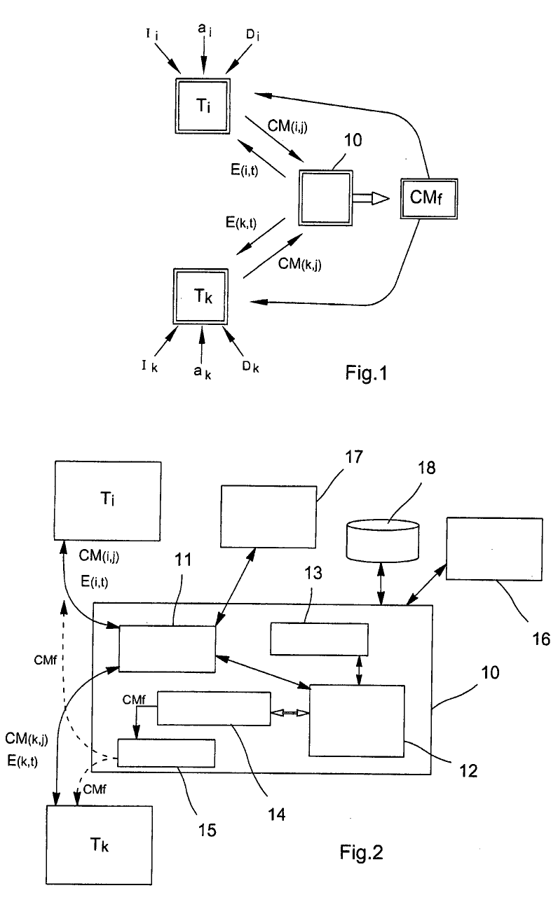

FIG. 1 shows a system for communication between terminals Ti, Tk and a platform 10 for remote collaborative creation of a final multimedia content CMf from a plurality of individual multimedia contents supplied to the platform 10 by the terminals Ti, Tk.

An individual multimedia content CM(i,j) represents the j^{th} contribution or j^{th} sending from the terminal Ti for the production of the final content CMf.

An individual content CM(i,j) is of the form:
CM(i,j)=I(i,j)+a(i,j)+D(i,j)
where I(i,j) is the j^{th} image stream sent by the terminal Ti, a(i,j) is the j^{th} audio stream sent by the terminal Ti and D(i,j) is the metadata associated with these streams.

In return, the terminals Ti, Tk can receive messages concerning the status of the system. A status message E(i,t) contains information concerning the system at the time t, this information being fed back to the terminal Ti.

In the remainder of the description the term “shoot” refers to all exchanges between the terminals Ti, Tk and the system for producing the final multimedia content CMf.

FIG. 2 shows in detail the content of the production platform 10. This figure shows a module 13 adapted to generate a scenario made up of a plurality of multimedia sequences. This scenario is decided on in advance, at the beginning of the shoot, by one or more participants. The composition of the scenario in terms of the sequences initially defined can nevertheless be modified in the module 13 during the shoot.

For example, participants might decide to collaborate on the production of a short film on the occasion of a wedding, each participant having a terminal. Under such circumstances, the scenario is the “wedding” scenario referred to in the scenario generation module 13. With this “wedding” scenario the generator associates a plurality of sequences “arrival of the bride”, “leaving the register office”, “toast”, “reception”, etc. Participants feed these sequences with individual multimedia contents or add new sequences during the shoot.

At the end of the shoot, the sequences are processed by the system of the invention to produce the final multimedia content CMf constituting the intended short film.

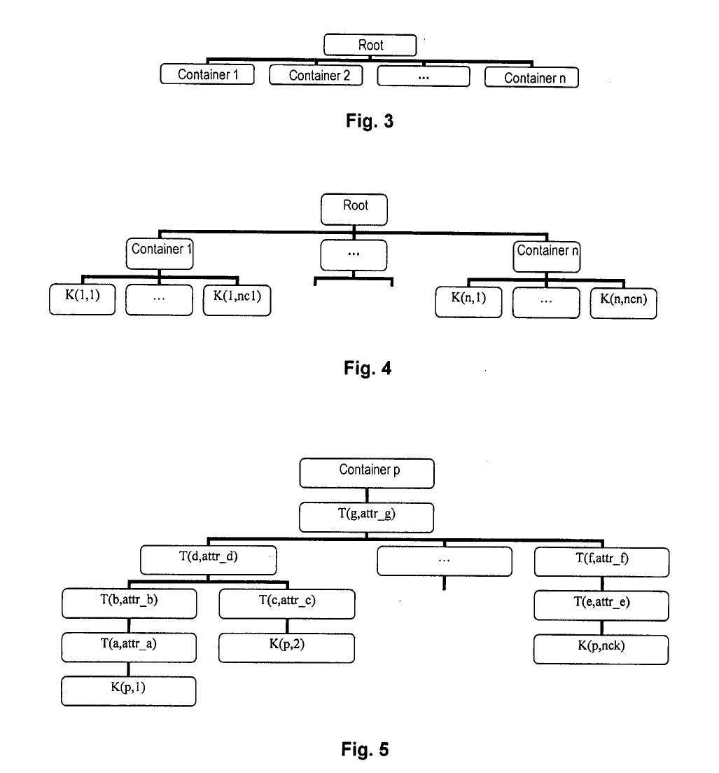

As shown in FIG. 3, the individual multimedia contents CM(i,j) are managed by means of a data structure in the form of a tree from a shoot initialization stage through final editing of the sequences and broadcasting of the final multimedia content CMf.

This tree data structure is created in the generation module 13 during the initialization stage as a tree having a root node, corresponding to the “wedding” scenario, for example, and a number of offspring nodes called containers and corresponding to the various sequences of the root scenario.

The tree data structure shown in FIG. 3 may be produced in XML, for example.

A container groups together individual contents CM(i,j) relating to the same sequence. Using containers therefore makes it possible to structure the multimedia contents in the manner represented in FIG. 4.

When a terminal Ti supplies an individual content CM(i,j), the corresponding metadata D(i,j) includes an indicator of a corresponding sequence or container. This indicator can be the number p of the container associated with the content. In the selected example, p is a number from 1 to n. The individual contents CM(i,j) can therefore be numbered in the form K(p,q), where K(p,q) represents the qth individual multimedia content in a container p. There is of course a one-to-one relationship between K(p,q) and CM(i,j).

The indicator can equally be a title associated with the container, for example “leaving the register office” in the “wedding” scenario referred to above, it being understood that the system is capable of making semantic connections and recognizing the indicator “register office” as relating to the “leaving the register office” container.

However, it is also possible for an indicator not to be associated with a container of an existing sequence. The system is then able to detect the new sequence and create a new container in the tree structure. Still in the context of the “wedding” scenario, a participant might create a multimedia content relating to the bridesmaids and associates the title “bridesmaids” with it, by means of an indicator, although no such container exists in the tree. The system responds by taking account of this new sequence and adding a container called “bridesmaids” to the existing tree.

The system of the invention also offers the possibility of modifying individual multimedia contents and how they are combined to produce the final content CMf. This entails applying transformations T to the multimedia contents.

A transformation T is applied to one or more individual multimedia contents and its result is another, modified multimedia content. Applying transformations T to the FIG. 4 tree structure creates additional nodes, as shown in FIG. 5.

A transformation is defined by two arguments, namely its type a, b, c, etc. and its parameters attr_a, attr_b, attr_c, etc. Examples of types are: reduce audio level, switch to black and white, slow motion, insert sub-title, fade to black between two different contents. The parameter for the reduce audio level type is −10 dB, for example. The transformation T(a, attr_a) is then understood as meaning “reduce the audio level by 10 dB”.

The system manages a video conversion library and transformation utilities in its memory. For example, the system can use the video library ffmpeg as a multimedia conversion library.

The FIG. 5 structure reflects the overall status of the multimedia contents and is used as an editing rule for generating the final content CMf.

The system of the invention is described in detail next with reference to FIG. 2.

Each terminal Ti, Tk of a user participating in the shoot contains an application able to communicate with the platform 10, i.e. to send individual contents CM(i,j) and receive in return status messages E(i,t), including the final multimedia content created by means of the platform 10.

Communication between the terminals and the platform 10 can be synchronous or asynchronous.

With mobile telephones, asynchronous communication between a terminal and the platform can be provided by the MMS client of the terminal. In a PC environment, the messaging client can provide this function.

An application (Java, Symbian, Windows, etc.) can set up synchronous communication with the platform whether the terminal is a mobile terminal or a PC.

Moreover, the terminals can be equipped with a communication interface. In particular, the final content CMf can be played on the terminal by means of multimedia players that are increasingly widespread not only on a PC but also on mobile terminals.

The transceiver stage 11 provides communication between the platform 10 and the terminals Ti.

In particular, this stage 11 splits multimedia contents CM(i,j) into their component parts I(i,j), a(i,j) and D(i,j) and extracts the identifier i of the user, the indicator of the contribution, and information relating to the communication context.

Conversely, the stage 11 sends pertinent information from the platform 10 to the terminals Ti during the shoot, in particular status messages E(i,t).

For splitting contents CM(i,j) into their component parts, a practical option is for MMS contents sent by a mobile terminal or video files sent as attachments to electronic mail messages to be analyzed by means of common script languages (Peri, php, python, etc.).

Communication of the platform 10 with the terminals Ti may be asynchronous (MMS, SMS or electronic mail) or synchronous and linked to a dedicated application in the terminals.

The central unit 12 is the management unit for the system as a whole. Its role is to coordinate the actions of the various components from initializing a shoot through generating the final content CMf by gathering together the individual contents CM(i,j).

To fulfill this role, the central unit 12 provides three main functions:

a) Interpreting individual contents CM(i,j) previously split into their component parts I(i,j), a(i,j) and D(i,j) by the stage 11 in order to execute appropriate actions in relation to the other components.

b) Sending messages E(i,t) to the terminals Ti corresponding to the status of the shoot in order to communicate the instructions necessary for it to progress properly.

c) Communicating with other components of the platform 10.

In terms of the function a), the central unit 12 is a system for interpreting and managing contents CM(i,j) in order to select appropriate actions as a function of the splitting into component parts I(i,j), a(i,j) and D(i,j), and in particular:
initializing a shoot;
ending a shoot;
inserting a contribution j;
editing a contribution j;
launching generation of the final content CMf.

In terms of the function b), the central unit 12 sends pertinent information to the terminals Ti in order to animate the shoot, among other things by informing the users of its progress, and in particular:
notifying launching of shoot;
notifying arrival of new contributions;
notifying ending of shoot;
notifying production of the final content CMf;
notifying broadcasting of the final content CMf.

In terms of the function c), the central unit 12 interacts with the other components of the platform 10 as a function of individual contents CM(i,j) and status messages E(i,t):
with the generator 13, to create a scenario;
with a memory 16, to store new contributions;
with the production module 14 and the broadcast stage 15 at the end of the shoot, to generate and distribute the final content CMf.

The central unit 12 can be produced using a commercial programming environment (Java, C++, perl, php, etc.) including client/server modules and can interwork with the other components via application programming interfaces (API).

As explained above, the scenario generation module 13 creates a tree structure analogous to that of FIG. 3 that is then used throughout the shoot or enriched during a shoot as a function of an indicator included in the metadata D(i,j) sent by the terminals Ti to the platform 10.

The production module 14 scans the tree data structure described with reference to FIG. 5 in depth to generate the final multimedia content CMf.

For this purpose the module 14 uses functions from the video conversion library and transformation utilities. These functions can be combined, which makes it possible to apply successive transformations to ascending levels of the tree data structure.

The stage 15 broadcasts the final content CMf generated by the production module 14 to the terminals Ti. This broadcasting can be effected by means of a video packet streaming platform for distributing contents to mobile terminals.

The system 17 moderates the individual contents CM(i,j) sent to the platform 10 and the final content CMf generated. Its activation during a shoot depends on the editorial policy of the shoot manager and can be optional. This function can be provided by a particular terminal Ti that displays all the individual contents CM(i,j) and validates integration thereof into the final content CMf.

The system has a memory space 16 that is sufficient for all the processing needed for a shoot to proceed correctly.

This system memory 16 manages in particular:
the scenarios, in conjunction with the module 13;
the individual contents CM(i,j);
the transformations library;
the final content or contents CMf.

The database 18 for managing the individual contents CM(i,j) uses an XML model to describe the tree data structure.

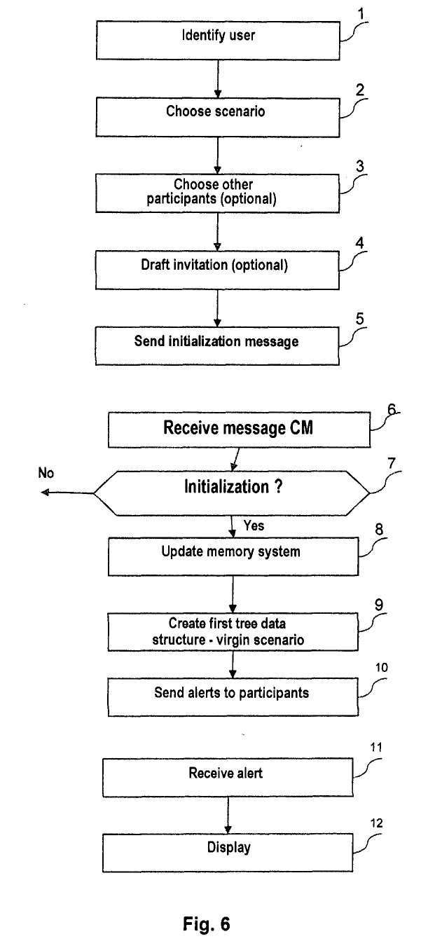

The progress of a shoot involving contributor participants and leading to the collective production of a final multimedia content is described below with reference to FIGS. 6 to 8.

The shoot initialization stage is shown diagrammatically in the FIG. 6 diagram.

To initialize a shoot, a user must first compose a message to the platform 10. This user can be either one of the participants or a content production service administrator.

The message includes the following fields:
user identifier (this can be a mobile terminal telephone number or a PC identifier);
scenario type;
where applicable, other participant identifiers (for example mobile telephone numbers).

To find out which types of scenario are available from the module 13, the user can refer to advertisements or consult a web site linked to the service from a mobile telephone or a PC.

The first user can add a personalized message to other participants.

Once the message has been composed, the terminal sends it to the transceiver stage 11.

When it receives a message, the transceiver stage 11 extracts data from it and forwards the data to the central unit 12, which first identifies the type of message it has been sent. In the present example, this is an initialization message.

The central unit 12 then creates a unique identifier to be associated with this shoot. It stores in the memory 16 the information needed for the shoot to proceed correctly, in particular the various identifiers.

The central unit 12 then calls on the module 13 to create the tree data structure that defines the scenario. To this end it sends the scenario type contained in the initialization message and where appropriate the identifiers of the participants.

Finally, if the initialization message contains participant identifiers, the central unit 12 sends a request to the stage 11 for it to send an alert message to all participants to inform them of the starting of the shoot. This request consists of:
the shoot identifier;
the participant identifiers;
an information message that can contain text, pictures, and audio.

The transceiver stage 11 composes and sends the message for each participant.

Depending on the type of scenario selected for the shoot, the information message can be personalized: for example, it can inform each participant of the shooting style to be adopted.

The shoot identifier can also be broadcast to other participants via various information means, such as poster or audiovisual advertisements, independently of the service itself.

The addressee terminal receives the information message and shows the user the data contained therein, such as:
shoot rules;
possible scenario sequences;
shoot identifier to be used to communicate with the central unit 12.

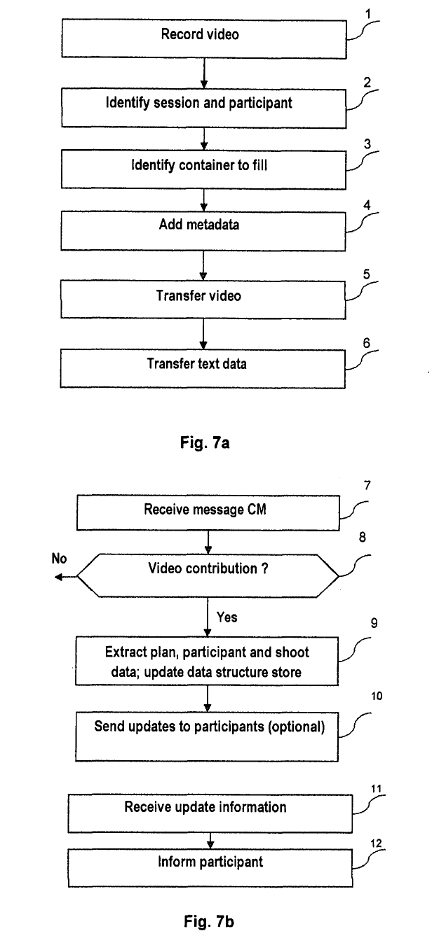

FIG. 7a shows how a participant can make a contribution to the shoot in a nominal stage in the form of a video-type individual multimedia content CM(i,j).

To participate in a shoot, a participant must first store a multimedia content, which is a video clip in this example. This can be done in two ways:
either “live”, for example using a digital camera integrated into a mobile terminal;
or by importing a video file stored beforehand in the mobile terminal.

The user must then fill in the metadata fields D(i,j) needed for processing the contribution:
shoot identifier;
container or sequence identifier.

The user can also include in the metadata D(i,j) information for influencing the editing of the final video, for example:
erase audio;
rating;
description;
subtitle.

The terminal automatically adds data concerning the shooting time, the format, etc. to the video clip.

A message containing only the shoot identifier and a shot identifier can be sent afterwards to update the data for editing the specified shot.

The audio/video data is then transferred to the platform 10.

FIG. 7b shows the reception and processing of an individual video content CM(i,j).

The central unit 12 identifies the message received as a video contribution, stores the audiovisual data and the associated metadata in the system memory 16, and finally updates the data structure.

If the moderation system 17 is activated, the contribution is stored in an inactive state until the moderator activates it. An inactive contribution cannot be used to generate the final content CMf.

During this step, when a participant has added a new contribution to a container, a reception indicator or thumbnail representing the shot is extracted and presented immediately to the other participants over their communication interface in a message E(i,t) accompanied by associated useful information such as the shot identifier. If so desired, a participant can view the whole of the new shot by activating the corresponding menu via the communication interface and can send to the platform 10 in the metadata D(i,j) comments or additions to the subject of the contribution just viewed. This data can influence the editing rule.

If the contribution comes from a new participant, the central unit 12 stores the information in order to be able to alert that new participant of the end of the shoot.

Depending on the type of scenario selected, no information messages are sent, an information message is sent to only one participant or a collective message is sent. This enables sequencing of the completion process: participants send their contributions one after the other, for example, or all at the same time.

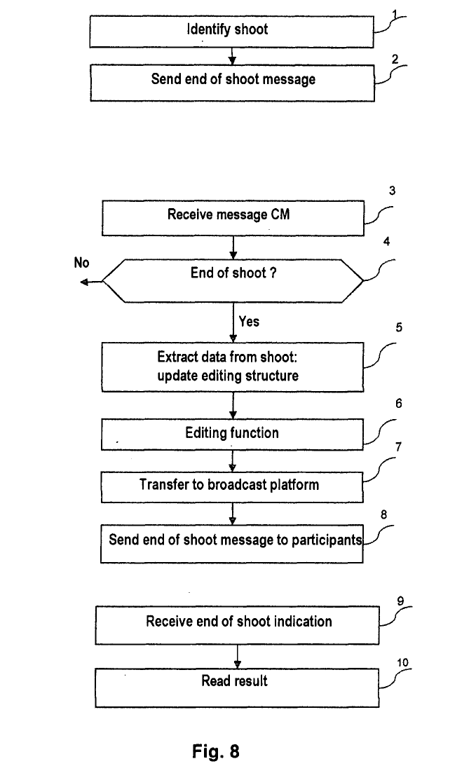

FIG. 8 shows steps which at the end of the shoot display the final multimedia content CMf edited from the various contributions.

Depending on the scenario selected, the shoot initiator can decide at any time to end it or to wait for all the containers to be filled in.

To end the shoot and view the final content, the user must identify a shoot and then send a message containing the instruction to proceed with editing.

The central unit 12 receives the instruction to end the shoot. It updates the database and the tree data structure and then sends the information to the production module 14, which applies an editing rule corresponding to the tree structure of the selected scenario.

When the final content CMf is obtained, the module 14 transfers it to the broadcast stage 15 and then informs the central unit 12 that the participants can consult the result.

The central unit 12 composes a status message E(i,t) that the transceiver stage 11 sends to the terminal Ti. This message includes:
a summary of the shoot;
a pointer to the result.

Once the final content has been completed, the participants receive an alert inviting them to consult the result. The consultation mode (downloading or streaming) depends on the broadcasting platform and the terminal.

What is claimed is:

1. A communication system for remote collaborative creation of a final multimedia content from a plurality of individual multimedia contents, the communication system comprising:
a module for generating a scenario for said final multimedia content, said scenario including a tree structure having at least one multimedia sequence;
a plurality of terminals each adapted to send at least an individual multimedia content having multimedia data and metadata including an indicator relating to a multimedia sequence to which said individual multimedia content relates; and
a server for producing said final multimedia content by processing the individual multimedia contents sent by the terminals in accordance with said tree structure and in accordance with a given editing rule.

2. The system according to claim 1, wherein said indicator concerns a multimedia sequence that exists beforehand in the tree structure.

3. The system according to claim 1, wherein said indicator concerns a new multimedia sequence and said generation module is adapted to add said sequence to the tree structure.

4. The system according to claim 1, wherein said editing rule includes concatenating individual multimedia contents of the same sequence of the tree structure.

5. The system according to claim 1, wherein said editing rule includes selecting a single individual multimedia content in a sequence of the tree structure.

6. The system according to claim 1, wherein said editing rule includes applying transformations to the individual multimedia contents of the same sequence of the tree structure.

7. The system according to claim 6, wherein said metadata contains information concerning the application of said transformations at the time of editing the final multimedia content.

8. The system according to claim 1, wherein said metadata includes information concerning the constitution of said editing rule.

9. The system according to claim 1, including a system for moderating individual multimedia contents sent by the terminals.

10. The system according to claim 1, wherein the terminals have a communication interface that includes an indicator of reception of said last individual multimedia content by a platform for producing the final multimedia content.

11. A terminal for remote collaborative creation of a final multimedia content from a plurality of individual multimedia contents, the terminal being adapted to send an individual multimedia content consisting of multimedia data and metadata including an indicator concerning a multimedia sequence to which said individual multimedia content relates in a tree structure constituting a scenario for said final multimedia content.

12. A production platform for remote collaborative creation of a final multimedia content from a plurality of individual multimedia contents, said platform comprising:
a module for generating a scenario for said final multimedia content, said scenario consisting of a tree structure consisting of at least one multimedia sequence;
a transceiver stage for receiving individual contents sent by terminals, an individual content having multimedia data and metadata including an indicator relating to a multimedia sequence to which said individual multimedia content relates, and said transceiver stage being adapted to split individual contents into their component parts and to extract said indicator from said metadata; and
a server for producing said final multimedia content by processing individual multimedia contents sent by terminals in accordance with said tree structure and in accordance with a given editing rule.

13. A production method for remote collaborative creation of a final multimedia content from a plurality of individual multimedia contents, the production method comprising the steps of:
generating,a scenario for said final multimedia content, said scenario including a tree structure consisting of at least one multimedia sequence;
receiving individual contents sent by terminals, an individual content having multimedia data and metadata including an indicator relating to a multimedia sequence to which said individual multimedia content relates;
splitting the individual contents into their component parts and extracting said indicator from said metadata; and
producing said final multimedia content by processing individual multimedia contents sent by terminals in accordance with said tree structure and in accordance with a given editing rule.

14. A computer program including instructions for executing the method according to claim 13 when it is executed on a computer.
